(19) United States
(12) Patent Application Publication
(10) Pub. No.: US 2024/0312467 A1
(43) Pub. Date: Sep. 19, 2024

(54) VOICE AUTHENTICATION DEVICE AND APPLIANCE

(71) Applicant: ROHM CO., LTD., Kyoto (JP)

(72) Inventors: Koji TAMANO, Kyoto (JP); Takahiro NISHIYAMA, Kyoto (JP)

(21) Appl. No.: 18/596,879

(22) Filed: Mar. 6, 2024

(30) Foreign Application Priority Data
Mar. 13, 2023 (JP) 2023-038389
Nov. 6, 2023 (JP) 2023-189551

(51) Int. Cl. G10L 17/18; G10L 17/02; G10L 17/04; G10L 17/24; G10L 25/18

(52) U.S. Cl. CPC G10L 17/18; G10L 17/02; G10L 17/04; G10L 17/24; G10L 25/18

(57) ABSTRACT

A voice authentication device for incorporation in an appliance including a voice conversion portion configured to convert voice from outside into a voice signal that is an electrical signal includes a voice registration portion configured to learn a parameter of an AI model based on the voice signal, a voice verification portion configured to perform voice verification on input data based on the voice signal in accordance with an inference result yielded by the AI model having the learned parameter. The voice authentication is performed based on the voice registration portion and the voice verification portion.

### CROSS-REFERENCE TO RELATED APPLICATIONS

This application is based on and claims the benefit of priority from Japanese Patent Application No. 2023-038389 filed on Mar. 13, 2023 and Japanese Patent Application No. 2023-189551 filed on Nov. 6, 2023, the contents of both of which are hereby incorporated by reference.

### BACKGROUND OF THE INVENTION

### 1. Technical Field

The present disclosure relates to voice authentication devices.

### 2. Description of Related Art

Some known appliances perform voice authentication (see, for example, Japanese Patent Application No. 2010-211296). Voice authentication involves a process to register the features (for example, a voiceprint) of voice uttered by a human and a process to verify against the registered features.

### DESCRIPTION OF THE DRAWINGS

FIG. 1 is a diagram showing a voice authentication system according to a comparative example.

FIG. 2 is a diagram showing the configuration of a smart speaker according to an illustrative embodiment of the present disclosure.

FIG. 3 is a diagram showing an example of voice registration.

FIG. 4 is a diagram showing an example of voice verification.

FIG. 5 is a diagram showing the configuration of a three-layer neural network.

FIG. 6 is a schematic diagram of a voice signal.

FIG. 7 is a diagram showing the configuration of an appliance according to a modified example of the present disclosure.

### DETAILED DESCRIPTION

### 1. Comparative Example

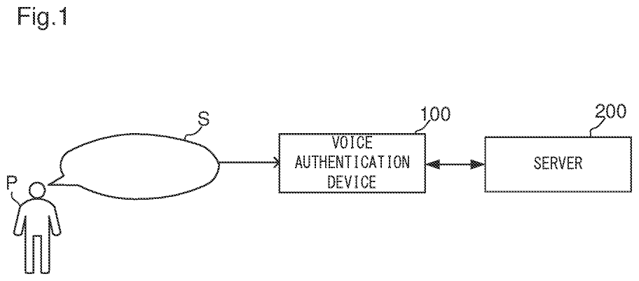

FIG. 1 is a diagram showing a voice authentication system according to a comparative example. The system shown in FIG. 1 includes a voice authentication device 100 and a server 200. The voice authentication device 100 communicates with the server 200.

In a registration process, voice S uttered by a user P is input to the voice authentication device 100 and the voice authentication device 100 transmits sound data related to the input voice S to the server 200. Based on the sound data transmitted to it, the server 200 performs a registration process to register the features of the voice S. In a verification process, when voice uttered by the user is input to the voice authentication device 100, the voice authentication device 100 transmits sound data related to the input voice to the server 200. Based on the sound data transmitted to it, the server 200 verifies it against the features of the voice S registered in a registration process. If the user in the verification process matches the user P in the registration process, the server 200 obtains a verification result indicating a match with the features of the registered voice S. By contrast, if the user in the verification process differs from the user P in the registration process, the server 200 obtains a verification result indicating a mismatch with the features of the registered voice S.

In a case where as a feature of the voice S, for example, a voiceprint is registered, a learning process is performed using a deep neural network as an AI (artificial intelligence) model. Learning with a deep neural network requires repeated solving of complex optimization problems, so for that purpose a processor with high processing power (GPU [graphics processing unit], AI-dedicated processor, or the like) is used in the server 200. For example, optimization is performed using stochastic gradient descent (SGD) according to Formula (1) below. Here, learning data set is divided into mini-batches and learning is repeated.

$${w}_{k + 1} = {w}_{k} - η ∇ L ( {w}_{k} ) \qquad ( 1 )$$

Here wₖ and wₖ₊₁ are weighting matrices, η is a learning coefficient, and ∇L is the gradient of a loss function.

As described above, in the comparative example, voice authentication requires communication with the server 200 and this leaves a security risk such as a leak of sound data. Furthermore, applying the comparative example described above to devices (such as household electrical appliances) that do not need to communicate with an external network for their functions other than voice authentication necessitates providing those device with a communication portion for voice authentication.

### 2. Smart Speaker

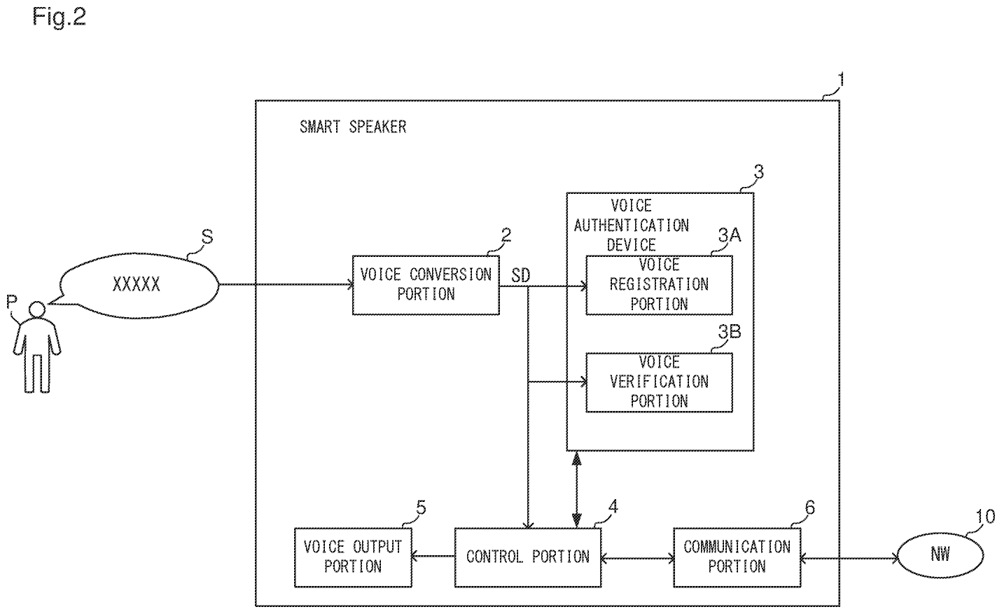

FIG. 2 is a diagram showing the configuration of a smart speaker 1 according to an illustrative embodiment of the present disclosure. The smart speaker 1 is an example of a device provided with a voice authentication device according to the present disclosure.

The smart speaker 1 includes a voice conversion portion 2, a voice authentication device 3, a control portion 4, a voice output portion 5, and a communication portion 6.

The voice conversion portion 2 has, for example, a microphone and an AD converter, and converts the voice S uttered by the user P into a voice signal SD that is an electrical signal. The voice authentication device 3 performs voice authentication by performing a registration process and a verification process based on the voice signal SD. The voice authentication device 3 will be described in detail later.

The control portion 4 controls the entire smart speaker 1. The voice output portion 5 has, for example, a speaker and a DA converter, and converts the voice signal into voice and externally outputs the voice. The communication portion 6 is an interface that communicates with an external communication network 10.

In the smart speaker 1, the control portion 4 performs a voice recognition process with respect to the voice S uttered by the user P. Thus, for example, a search keyword uttered with voice S by the user P is subjected to voice recognition by the control portion 4 and the control portion 4 transmits the search keyword via the communication portion 6 and the communication network 10 to an external server (not illustrated). In this case, sound data of music retrieved by the external server is transmitted via the communication network 10 to the communication portion 6 and the voice output portion 5 externally outputs the sound of the music based on the sound data. For another example, a command uttered with voice S by the user P is subjected to voice recognition by the control portion 4 and the control portion 4 transmits the command via the communication portion 6 and the communication network 10 to an external device (such as a smart household electrical appliance), which is thus operated.

### 3. Voice Authentication Device

As shown in FIG. 2, the voice authentication device 3 has a voice registration portion 3A and a voice verification portion 3B. The voice registration portion 3A performs a voice registration process based on the voice signal SD resulting from the input voice S being converted by the voice conversion portion 2. The voice verification portion 3B performs a voice verification process based on the voice signal SD resulting from the input voice S being converted by the voice conversion portion 2. In the voice verification process, verification against the registered voice is performed.

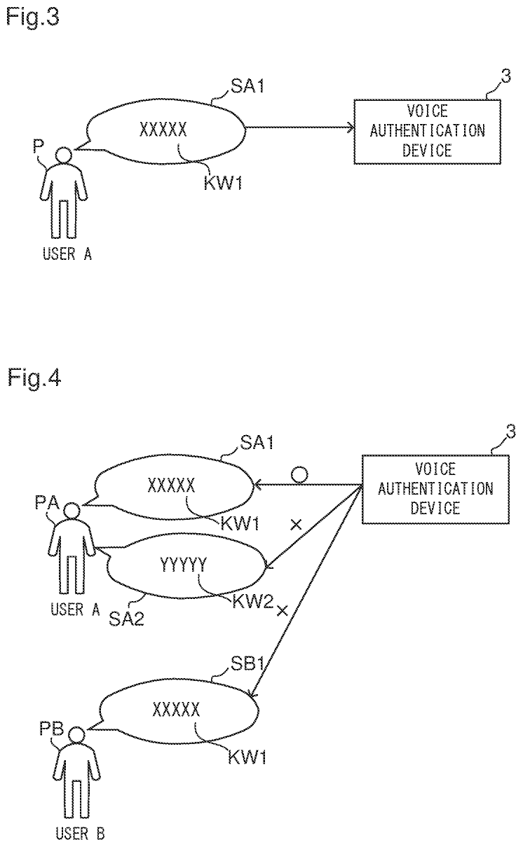

As shown in FIG. 3, a user PA who wants to be registered utters voice SA1 containing a specific keyword KW1 to input the voice SA1 to the voice authentication device 3. In this way, the voice registration portion 3A registers the voice SA1.

Next, as shown in FIG. 4, if the registered user PA utters the voice SA1 containing the specific keyword KW1, a verification process is performed by the voice verification portion 3B in the voice authentication device 3 and a verification result indicating a match with what is registered is obtained. In this case, for example, the use of the smart speaker 1 is allowed.

If, as shown in FIG. 4, the registered user PA utters voice SA2 containing a keyword KW2 different from the keyword KW1, a verification result indicating a mismatch with the registered voice is obtained. In this case, for example, the use of the smart speaker 1 is not allowed. If a user PB different from the registered user PA utters voice SB1 containing the keyword KW1, a verification result indicating a mismatch with what is registered is obtained.

### 4. Registration and Verification Processes Using a Three-Layer Neural Network

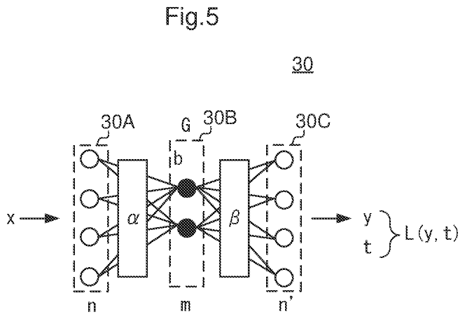

The voice registration portion 3A performs voice registration by performing an AI model learning process. In this embodiment, as the AI model, a three-layer neural network 30 as shown in FIG. 5 is used. Learning of a keyword can be fully implemented with a three-layer neural network without using a deep neural network.

As shown in FIG. 5, the three-layer neural network 30 is an AI model having an input layer 30A, a hidden layer 30B, and an output layer 30C. Generally, in the three-layer neural network 30, with respect to n-dimensional input data xϵR^{k×n} with a batch size k, the n′-dimensional inference result yϵR^{k×n′} is obtained as y=G(x·α+b)β. Here, αϵR^{n×m} is the weight with which the input layer 30A and the hidden layer 30B are connected and βϵR^{m×n′} is the weight with which the hidden layer 30B and the output layer 30C are connected. On the other hand, bϵR^{m} is the bias of the hidden layer 30B and G is the activation function of the hidden layer 30B.

In this embodiment, an algorithm that can sequentially learn the three-layer neural network 30 with a desired batch size is used. If i-th learning data {xᵢϵR^{ki×n}, tᵢϵR^{ki×n′}} of a batch size kᵢ is obtained, it is necessary to find βᵢ that minimizes the error according to Formula (2) below.

$$‖ [ \begin{matrix}{H}_{0} \\ ⋮ \\ {H}_{i}\end{matrix} ] {β}_{i} - [ \begin{matrix}{t}_{0} \\ ⋮ \\ {t}_{i}\end{matrix} ] ‖ \qquad ( 2 )$$

The i-th hidden layer matrix is Hᵢ=G(xᵢ·α+b). On the other hand, t is the teacher data corresponding to the inference result y.

The optimized weight βᵢ is calculated according to Formula (3) below.

$$\begin{matrix}{P}_{i} = {P}_{i - 1} - {P}_{i - 1} {{H}_{i}^{T} ( I + {H}_{i} {P}_{i - 1} {H}_{i}^{T} )}^{- 1} {H}_{i} {P}_{i - 1} \\ {β}_{i} = {β}_{i - 1} + {P}_{i} {H}_{i}^{T} ( {t}_{i} - {H}_{i} {β}_{i - 1} )\end{matrix} \qquad ( 3 )$$

Here, P₀ and βₒ can be calculated according to Formula (4) below.

$$\begin{matrix}{P}_{0} = {( {H}_{0}^{T} {H}_{0} )}^{- 1} \\ β0 = {P}_{0} {H}_{0}^{T} {t}_{0}\end{matrix} \qquad ( 4 )$$

The learning algorithm is as follows.
First, the values of the weight α and the bias b are initialized with random numbers.
Next, H₀ for x₀ is calculated and P₀ and β₀ are calculated.
Then, every time i-th learning data of a batch size kᵢ is obtained, Pᵢ and βᵢ are calculated sequentially.
Note that β₀ does not necessarily need to be calculated according to Formula (4); instead, a value initialized with a random number may be used as β₀.

In this embodiment, learning is performed using an autoencoder. The autoencoder reuses input data as it is as teacher data and learns so that the input data can be reconstructed as the inference result. That is, in the above example, it learns as t=x. The autoencoder does not require separately created teacher data and so is a type of unsupervised learning algorithm.

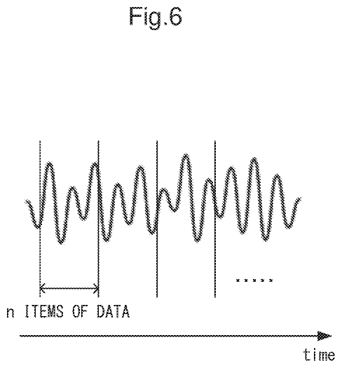

To register voice, first the user P (see FIG. 2) utters voice S containing a specific keyword; then, using sound data SD, which is time series data obtained through AD conversion of the voice S by the voice conversion portion 2, as 0-th input data x₀ of a batch size k₀, the voice registration portion 3A calculates P₀ and β₀ according to Formula (4) above. FIG. 6 schematically shows a voice signal, where one node in input data x constitutes one item of sampling data in the sound data SD and k sets of n items of sampling data (where n is the number of nodes in the input data x) arranged in a time series constitute input data of a batch size k.

Next, every time the user P utters new voice S containing a specific keyword, using time series data of the obtained sound data SD as i-th input data xᵢ of a batch size kᵢ, the voice registration portion 3A sequentially calculates Pᵢ and βᵢ according to Formula (3) above. Note that the number of times (a plurality of times) that the user P utters a keyword during the registration process is not particularly limited.

Then, to verify voice, first the user P (not necessarily the user at the time of registration) utters voice S containing a keyword; then, using sound data SD, which is time series data obtained through AD conversion of the voice S by the voice conversion portion 2, as input data x of a batch size k, the inference result y of the three-layer neural network is obtained. Then, verification is performed according to whether an error L (y, t)=L(y, x)=|y−x| exceeds a threshold value. If the error L does not exceed the threshold value, a verification result indicating a match with what is registered is obtained; if the error L exceeds the threshold value, a verification result indicating a mismatch with the registered voice is obtained. Note that the error L does not necessarily need to be calculated as described above, and may instead be calculated according to, for example, L=|y−x|².

As input data, a power spectrum obtained through frequency analysis of sound data SD may be used. In this case, each node in input data x corresponds to the power of a given frequency component.

Learning does not necessarily need to be performed using both Formulas (3) and (4) as described above; in a case where voice registration is performed using voice S uttered only once, learning can be performed using only Formula (4) above.

As described above, in this embodiment, the low processing load of the learning process permits the voice authentication device 3 to be implemented with a small and low-cost IC (integrated circuit), eliminating the need for an expensive processor. Thus, there is no need to perform the registration and verification processes on the external server via the communication network 10 and voice authentication can be completed within the smart speaker 1. It is thus possible to prevent a leak of sound data that is personal information and to enhance security. The voice registration and verification portions 3A and 3B may be implemented as a hardware circuit or as software.

### 5. Modified Example

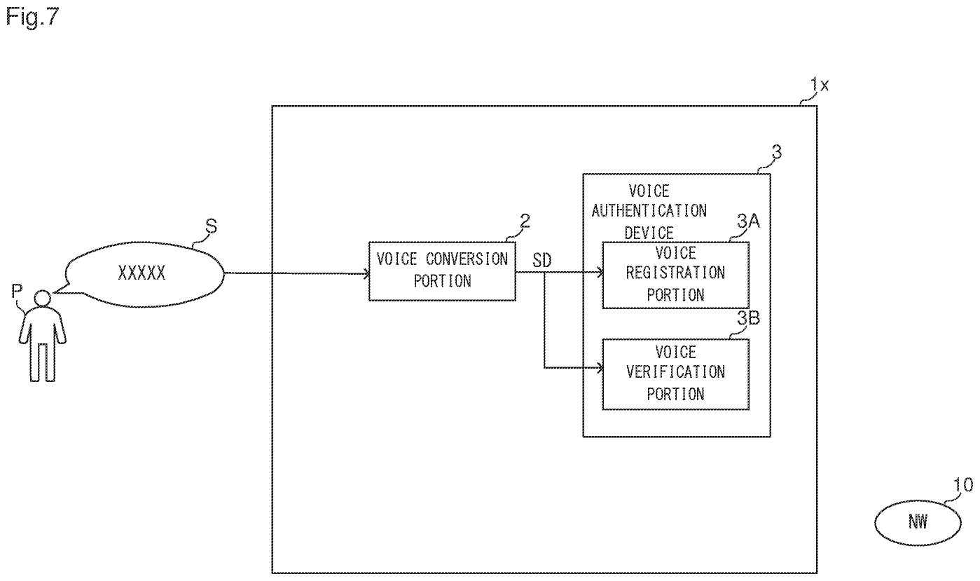

FIG. 7 is a diagram showing the configuration of an appliance 1x according to a modified example of the present disclosure. The appliance 1x is a device separated from an external network 10. That is, the appliance 1x does not have a communication portion that can communicate with a communication network 10. The appliance 1x is, for example, a household electrical appliance that is not connected to the communication network 10. FIG. 7 only shows the configuration of the part of the appliance 1x involved in the voice authentication function.

In this case, providing the voice conversion portion 2 and the voice authentication device 3 in the appliance 1x permits voice authentication to be accomplished within the appliance 1x. Thus, the appliance 1x no longer needs to be provided with a communication portion that communicates with the communication network 10 just for voice authentication and this helps achieve size reduction and cost reduction.

### 6. Others

An embodiment of the present disclosure allows for any modifications within the technical ideas recited in the claims. The various embodiments and modified examples described herein may be combined as appropriate unless inconsistent. The above embodiments are merely examples of embodiments of the present disclosure and the meanings of the terms used in the present disclosure and to described its features are not limited to those in which they are meant in the above embodiments.

### 7. Notes

As described above, according to one aspect of the present disclosure, a voice authentication device (3) for incorporation in an appliance (1) including a voice conversion portion (2) configured to convert voice (S) from outside into a voice signal (SD) that is an electrical signal includes:
a voice registration portion (3A) configured to learn a parameter of an AI model based on the voice signal;
a voice verification portion (3B) configured to perform voice verification on input data based on the voice signal in accordance with an inference result yielded by the AI model having the learned parameter;
wherein
the voice authentication is performed based on the voice registration portion and the voice verification portion (A first configuration).

In the voice authentication device of the first configuration described above, the voice registration portion and the voice verification portion may perform registration and verification respectively, each based on the voice including a keyword (A second configuration).

In the voice authentication device of the second configuration described above, the AI model may be a three-layer neural network (30) having an input layer (30A), a hidden layer (30B), and an output layer (30C) (A third configuration).

In the voice authentication device of the third configuration described above, the voice registration portion may calculate, as the parameter, the weight Bo with which the hidden layer and the output layer are connected according to Formula (A) below (A fourth configuration):

$$\begin{matrix}{P}_{0} = {( {H}_{0}^{T} {H}_{0} )}^{- 1} , \\ β0 = {P}_{0} {H}_{0}^{T} {t}_{0} ,\end{matrix} \qquad ( A )$$

where a hidden layer matrix Hᵢ=G (xᵢ· a+b), a is the weight with which the input layer and the hidden layer are connected, b is a bias of the hidden layer, G is an activation function of the hidden layer, xᵢ is i-th input data of a batch size kᵢ, and tᵢ is i-th teacher data of the batch size kᵢ.

In the voice authentication device of the third configuration described above, the voice registration portion may sequentially calculate, as the parameter, the weight βᵢ with which the hidden layer and the output layer are connected according to Formula (B) below (A fifth configuration):

$$\begin{matrix}{P}_{i} = {P}_{i - 1} - {P}_{i - 1} {{H}_{i}^{T} ( I + {H}_{i} {P}_{i - 1} {H}_{i}^{T} )}^{- 1} {H}_{i} {P}_{i - 1} , \\ {β}_{i} = {β}_{i - 1} + {P}_{i} {H}_{i}^{T} ( {t}_{i} - {H}_{i} {β}_{i - 1} ) ,\end{matrix} \qquad ( B )$$

where a hidden layer matrix Hᵢ=G (xᵢ· a+b), α is the weight with which the input layer and the hidden layer are connected, b is a bias of the hidden layer, G is an activation function of the hidden layer, xᵢ is i-th input data of a batch size kᵢ, and tᵢ is i-th teacher data of the batch size kᵢ.

In the voice authentication device of the fifth configuration described above, the voice registration portion may calculate the weight β₀ according to Formula (C) below (A sixth configuration):

$$\begin{matrix}{P}_{0} = {( {H}_{0}^{T} {H}_{0} )}^{- 1} , \\ β0 = {P}_{0} {H}_{0}^{T} {t}_{0} .\end{matrix} \qquad ( C )$$

In the voice authentication device of any one of the fourth to sixth configurations described above, the voice registration portion may perform learning assuming that tᵢ=xᵢ (A seventh configuration).

In the voice authentication device of any one of the fourth to seventh configurations described above, the input data may be sampling data of the voice signal (An eighth configuration).

In the voice authentication device of any one of the fourth to seventh configurations described above, the input data may be spectrum data obtained through frequency analysis of the voice signal (A ninth configuration).

According to another aspect of the present disclosure, an appliance (1) includes the voice authentication device (3) according to any one of the first to ninth configurations described above, the voice conversion portion (2), and a communication portion (6) that can communicate with a communication network (10) (A tenth configuration).

The appliance of the tenth configuration described above may be, for example, a smart speaker (An eleventh configuration).

According to yet another aspect of the present disclosure, an appliance (1x) includes the voice authentication device (3) according to any one of the first to ninth configurations described above and the voice conversion portion (2). The appliance is configured to be separated from a communication network (10) (A twelfth configuration).

What is claimed is:

1. A voice authentication device for incorporation in an appliance including a voice conversion portion configured to convert voice from outside into a voice signal that is an electrical signal, the voice authentication device comprising:
a voice registration portion configured to learn a parameter of an AI model based on the voice signal;
a voice verification portion configured to perform voice verification on input data based on the voice signal in accordance with an inference result yielded by the AI model having the learned parameter;
wherein
the voice authentication is performed based on the voice registration portion and the voice verification portion.

2. The voice authentication device according to claim 1, wherein
The voice registration portion and the voice verification portion perform registration and verification respectively, each based on the voice including a keyword.

3. The voice authentication device according to claim 2, wherein
the AI model is a three-layer neural network having an input layer, a hidden layer, and an output layer.

4. The voice authentication device according to claim 3, wherein
the voice registration portion calculates, as the parameter, a weight β₀ with which the hidden layer and the output layer are connected according to Formula (A) below:
$$\begin{matrix}{P}_{0} = {( {H}_{0}^{T} {H}_{0} )}^{- 1} , \\ β0 = {P}_{0} {H}_{0}^{T} {t}_{0} ,\end{matrix} \qquad ( A )$$
where a hidden layer matrix Hᵢ=G (xᵢ·α+b), α is the weight with which the input layer and the hidden layer are connected, b is a bias of the hidden layer, G is an activation function of the hidden layer, xᵢ is i-th input data of a batch size kᵢ, and tᵢ is i-th teacher data of the batch size kᵢ.

5. The voice authentication device according to claim 3, wherein
the voice registration portion sequentially calculates, as the parameter, a weight βᵢ with which the hidden layer and the output layer are connected according to Formula (B) below:
$$\begin{matrix}{P}_{i} = {P}_{i - 1} - {P}_{i - 1} {{H}_{i}^{T} ( I + {H}_{i} {P}_{i - 1} {H}_{i}^{T} )}^{- 1} {H}_{i} {P}_{i - 1} , \\ {β}_{i} = {β}_{i - 1} + {P}_{i} {H}_{i}^{T} ( {t}_{i} - {H}_{i} {β}_{i - 1} ) ,\end{matrix} \qquad ( B )$$
where a hidden layer matrix Hᵢ=G (xᵢ·α+b), α is the weight with which the input layer and the hidden layer are connected, b is a bias of the hidden layer, G is an activation function of the hidden layer, xᵢ is i-th input data of a batch size kᵢ, and tᵢ is i-th teacher data of the batch size kᵢ.

6. The voice authentication device according to claim 5, wherein
the voice registration portion calculates the weight β₀ according to Formula (C) below:
$$\begin{matrix}{P}_{0} = {( {H}_{0}^{T} {H}_{0} )}^{- 1} , \\ β0 = {P}_{0} {H}_{0}^{T} {t}_{0} .\end{matrix} \qquad ( C )$$

7. The voice authentication device according to claim 4, wherein
the voice registration portion performs the learning assuming that tᵢ=xᵢ.

8. The voice authentication device according to claim 4, wherein
the input data is sampling data of the voice signal.

9. The voice authentication device according to claim 4, wherein
the input data is spectrum data obtained through frequency analysis of the voice signal.

10. An appliance comprising:
the voice authentication device according to claim 1;
the voice conversion portion; and
a communication portion that can communicate with a communication network.

11. The appliance according to claim 10, wherein the appliance is a smart speaker.

12. An appliance comprising:
the voice authentication device according to claim 1; and
the voice conversion portion,
wherein
the appliance is configured to be separated from a communication network.
